(19) United States
(12) Patent Application Publication
(10) Pub. No.: US 2019/0220759 A1
(43) Pub. Date: Jul. 18, 2019

(54) Method and Apparatus for Visual and Exploratory Multi-Dimensional Search of Geographic Information System Data

(71) Applicant: Katerra, Inc., Menlo Park, CA (US)

(72) Inventor: Patrick Tierney, San Francisco, CA (US)

(21) Appl. No.: 15/874,547

(22) Filed: Jan. 18, 2018

(51) Int. Cl. G06N 5/04; G06T 17/05

(52) U.S. Cl. CPC G06N 5/046; G06T 2200/24; G06T 17/05

(57) ABSTRACT

A system selects a region, or sub-region therein, for locating a building site. The system allows for selection of one or more rules and factors to consider in selecting a building site, and the receiving of input to select a range of values for one or more of the selected rules and factor(s). A map is displayed on a display screen depicting each of a plurality geographic regions in a manner that indicates a relative score for a building site in the geographic region based on the selected rules and factor(s) and the selected range of values for the one or more of the selected rules and factor(s). User input is received to subdivide one of the plurality of geographic regions into a plurality of geographic sub-regions, and the map redisplayed on the display screen depicting each of the plurality geographic sub-regions in a manner that indicates the relative score for a building site in the geographic sub-region based on the selected rules and factor(s) and the selected range of values for the one or more of the selected rules and factor(s). User input is received to display on the display screen a plurality of property parcels for or within one of the plurality of geographic sub-regions, and to select one or more of the displayed plurality of property parcels on which to perform a function.

### RELATED APPLICATIONS

N/A

### TECHNICAL FIELD

The invention relates to Geographic Information System (GIS) mapping software, including allowing a user to set “desirability”, or search criteria, for GIS data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

For purposes of selecting a building site for a construction project, regions such as counties, townships, or boroughs, are typically subdivided into neighborhoods, with addresses assigned to specific property parcels. When subdividing a region into one or more property parcels for the purpose of selecting one or more parcels as the site for a building project, numerous factors are usually considered.

Commonly employed techniques for building site selection are considerably lacking in sophistication. In many cases, selection is done by hand, on paper, in an office. In some cases, professional staff is employed to site building projects using commercial, off-the-shelf Geographic Information System (GIS) software. ArcGIS, a GIS software tool available from Esri, of Redlands, Calif., is an example of such software.

Even with GIS software, building site selection is a lengthy, resource-intensive, trial-and-error process that inherently results in inefficiencies and a multitude of errors. The typical approach requires highly-skilled GIS technicians who possess both technical proficiency and understand nuances of local laws, federal laws, zoning requirements, etc. In order to select a building site, GIS technicians might overlay a variety of geographic layers (e.g., legislative boundaries, school districts, sanitary districts, etc.) while at the same time mentally balancing other competing considerations. The trial-and-error process is challenging given the many dimensions that GIS technicians need to consider simultaneously.

At the end of the day, the advent of GIS software has not changed the building site selection process much. What is needed is an improved product and process by which to select a building site for a construction project.

### SUMMARY

A system selects a geographic region, e.g., a state, a region, a sub-region, a neighborhood, an area, etc., in which to locate a building site, whether for a home, multi-family dwellings, commercial real estate, a campus, or factories, etc. The system allows for selection of one or more factors to consider in selecting a building site, and the receiving of input to select a range of values for one or more of the selected factor(s). A map is displayed on a display screen depicting each of a plurality geographic regions in a manner that indicates a relative score for a building site in the geographic region based on the selected factor(s) and the selected range of values for the one or more of the selected factor(s). User input is received to subdivide one of the plurality of geographic regions into a plurality of geographic sub-regions, and the map redisplayed on the display screen depicting each of the plurality geographic sub-regions in a manner that indicates the relative score for a building site in the geographic sub-region based on the selected factor(s) and the selected range of values for the one or more of the selected factor(s). User input is received to display on the display screen a plurality of property parcels for or within one of the plurality of geographic sub-regions, and to select one or more of the displayed plurality of property parcels on which to perform a function. For example, user input is received to subdivide the parcels, and the system re-evaluates the resulting subdivision based on the criteria marked by the user, in the local, sub-regional, regional, national, and global scales.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1A is a flow diagram of an embodiment of the invention.

FIG. 1B is a flow diagram of another embodiment of the invention.

FIG. 2 is a map display illustrating an aspect of an embodiment of the invention.

FIG. 3A is a map display illustrating an aspect of an embodiment of the invention.

FIG. 3B is a map display illustrating an aspect of an embodiment of the invention.

FIG. 4A is a map display illustrating an aspect of an embodiment of the invention.

FIG. 4B is a map display illustrating an aspect of an embodiment of the invention.

FIG. 5A is a map display illustrating an aspect of an embodiment of the invention.

FIG. 5B is a map display illustrating an aspect of an embodiment of the invention.

FIG. 6 is a map display illustrating an aspect of an embodiment of the invention.

FIG. 7A is a map display illustrating an aspect of an embodiment of the invention.

FIG. 7B is a map display illustrating an aspect of an embodiment of the invention.

FIG. 7C is a map display illustrating an aspect of an embodiment of the invention.

FIG. 7D is a map display illustrating an aspect of an embodiment of the invention.

FIG. 7E is a map display illustrating an aspect of an embodiment of the invention.

FIG. 7F is a map display illustrating an aspect of an embodiment of the invention.

FIG. 8 illustrates a diagrammatic representation of a machine in the exemplary form of a computer system, in accordance with one embodiment.

FIG. 9 is a flow diagram of an embodiment of the invention.

### DETAILED DESCRIPTION

Embodiments of the invention relate to a building site selection software tool. In one embodiment, the tool is a decision-making and property parcel-identification software tool that automates the building site selection process for a given project through a web-based interface. Embodiments of the invention solve the problem of finding the optimum site to develop a building project, based on multiple internal and external sources of data related to building development.

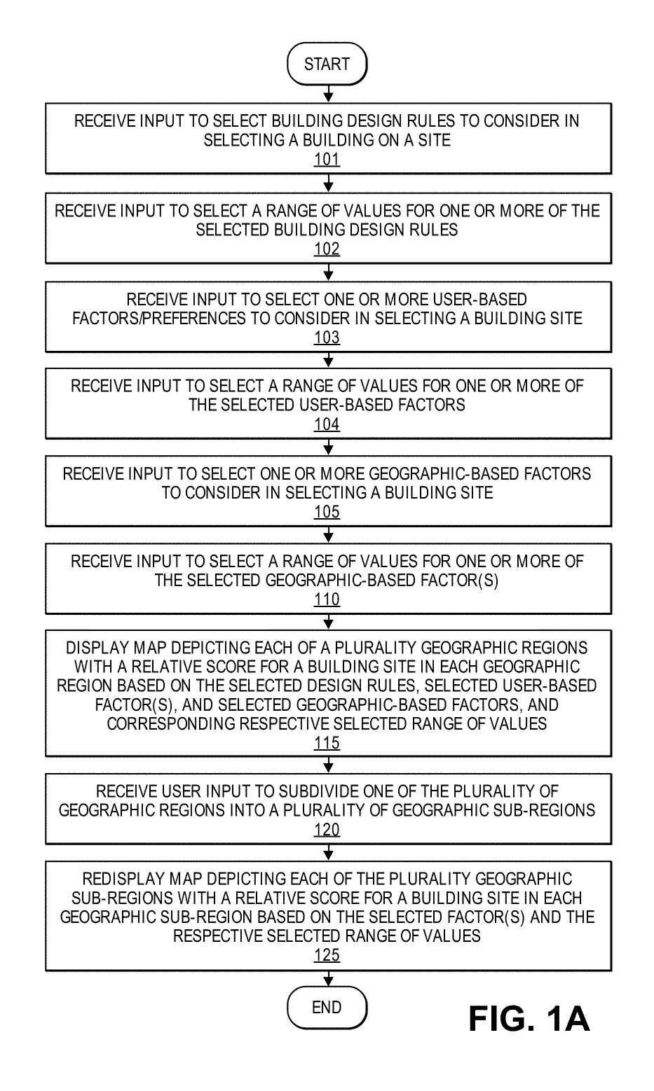

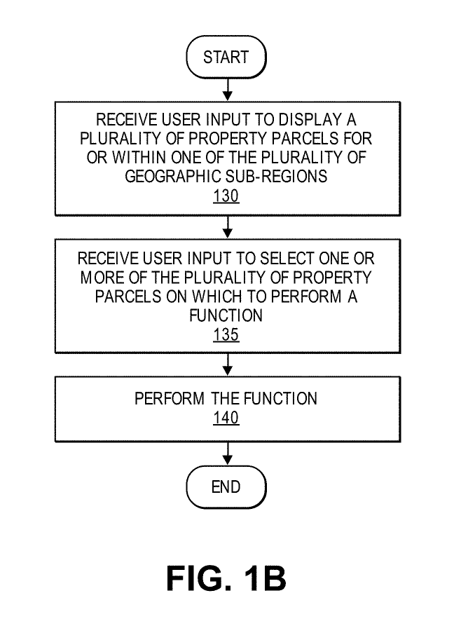

FIG. 1A depicts a flow diagram illustrating various aspects of methods according to embodiments of the invention. These methods may be performed by processing logic that may include hardware (e.g., circuitry, dedicated logic, programmable logic, microcode, etc.) and software (e.g., instructions run on a processing device) to perform various operations such as designing, defining, retrieving, parsing, persisting, exposing, loading, executing, operating, receiving, generating, storing, maintaining, creating, returning, presenting, interfacing, communicating, transmitting, querying, processing, providing, determining, triggering, displaying, updating, sending, etc., in pursuance of the systems and methods as described herein.

Embodiments of the invention have access to a database that stores therein a number of generative, or building, design rules. In the embodiments, software instructions that when executed by the processor cause the system to generate a building project design based on the generative design rules. In one embodiment, the generative design rules limit the building project design to a subset of possible permutations. In one embodiment, and with reference to FIG. 1A, the generative design rules are selected by processing logic 101 from a number of generative design rules including but not limited to building design rules, site design rules, functionality rules, appearance or aesthetic rules, and circulation rules. In one embodiment, the generative design rules substantially adhere to various codes and/or guidelines, including but not limited to municipal building codes, state building codes, federal building codes, international building codes, building design codes, aesthetic guidelines, and design rules relating to a building site, a building on the building site, and a location of a building on the building site.

In one embodiment, a computer system, having a processor and a memory therein, executes software instructions to cause the system to generate a building project design based on the generative design rules, including to select a range of values for one or more of the selected building design rules, such as selecting a subset of the building elements, and combine the selected subset of building elements according to the generative design rules into the building project design. In one embodiment, the software instructions that when executed by the processor cause the system to select a subset of the building elements further cause the system, using processing logic 102, to receive user input via the UI to select the subset of building elements.

The described embodiments of the invention may make use of building elements and building element interfaces. Embodiments of the invention synthesize a building, in part or in whole, by combining (or configuring) a set of pre-fabricated building elements with specified building element interfaces using building design rules. The building elements can be configured in different combinations to create a large number of possible building permutations. These various permutations create buildings with a wide range of appearance and functionality, giving the occupant the experience of a custom design based on a standard set of building elements. The specific building design rules limit the possible ways building elements may be combined. For example, the building design rules may anticipate a series of potential options that tree and branch from the circulation of the building. Circulation, in the field of architecture, refers to the way people move through and interact with a building. For example, the circulation of a garden style apartment could be interpreted as climbing stairs to a landing, entering the apartment unit through an entry door into the apartment entry way.

One embodiment of the invention contemplates building elements of fixed dimensions which limit the possible synthesizable building solution space. One embodiment is simplified if the dependencies of a bill of materials (BOM) of a parametric building element automatically adjusts to the changes in parameters, e.g., if the dimensions of a kitchen expand then the placement of the fixtures in that kitchen automatically adjust to the expanded dimension.

In one embodiment, the software instructions that when executed by the processor cause the system to combine the selected subset of building elements according to the generative design rules into the building project design cause the system to combine the selected subset of building elements according to the generative design rules into a proposed building project design. The embodiment then evaluates a number of geometric relationships between the combined selected subset of building elements in the proposed building project design as acceptable according to a set of criteria selected, and identify the proposed building project design as the final building project design based on the evaluation of the geometric relationships between the combined selected subset of building elements in the proposed building project design as acceptable according to the set of criteria. In such an embodiment, the system may receive user input via the UI to select the geometries of building elements and geometric relationships between or among building elements at 102.

Thus, as described above, embodiments of the invention gather and store information about the particulars of building construction in a database, then use that information with a set of algorithms to generate designs, details, and/or specifications for each part of the building construction supply chain. Embodiments of the invention then evaluate the generated design, for example, against a fitness function, wherein the fitness function is a mathematical function of the various metrics discussed earlier (install cost, install time, constructability, energy usage/sustainability, structural/loading analysis, return on investment). Through the use of an optimization algorithm, the design, detailing, and specification parameters converge to an optimum set of parameters for a building location, time, budget, energy use, and/or other constraints.

With reference again to FIG. 1A, processing logic 103 optionally receives input to select one or more user-based factors or preferences to consider in selecting a building site. In one embodiment, the input is received from a user, for example, via a keyboard, and/or in the absence of such the embodiment relies on machine input to select the one or more user-based factors to consider in selecting a building site. In another embodiment, an initial or default set of user-based factors are selected by the system, e.g., machine input, and/or based on previously received user input. User-based factors may be custom factors, separate and apart from preferences for building design rules and/or geographic-based factors, and respective ranges of values thereof, or the user-based factors may overlap and/or override selected building design rules and/or geographic-based factors and respective selected ranges thereof, such as, for example, a builder's or developer's preference for building type, size, finish levels, geographic location, neighborhood, parcel characteristics, geological hazards (steep slopes, landslide activity, flood zone, fire zone, earthquake hazards), noise complaints/variances, land use (districts: historic, business, conservation, etc.), and jurisdictional boundaries (state, county, city, school district, zoning).

One embodiment of the invention allows for weighting of one or more of the selected user-based factors. So, for example, if two user-based factors, such as a desired geographic region and schedule for building, are selected, the embodiment receives input that may weight one factor at greater than the other factor. In another embodiment, if more than two user-based factors (UFₙ) are selected, user input is received for at least UFₙ₋₁ user-based factors and the embodiment then weights the n selected user-based factors accordingly.

Processing logic at 104 further receives input to select a range of values for one or more of the selected user-based factors to consider in selecting a building site. In one embodiment, the input is received from a user, for example, via a keyboard or mouse, and/or in the absence of such the embodiment relies on machine input to select the range of values for one or more of the selected user-based factors to consider in selecting a building site. In another embodiment, an initial or default range is configured for each selected user-based factor by the system.

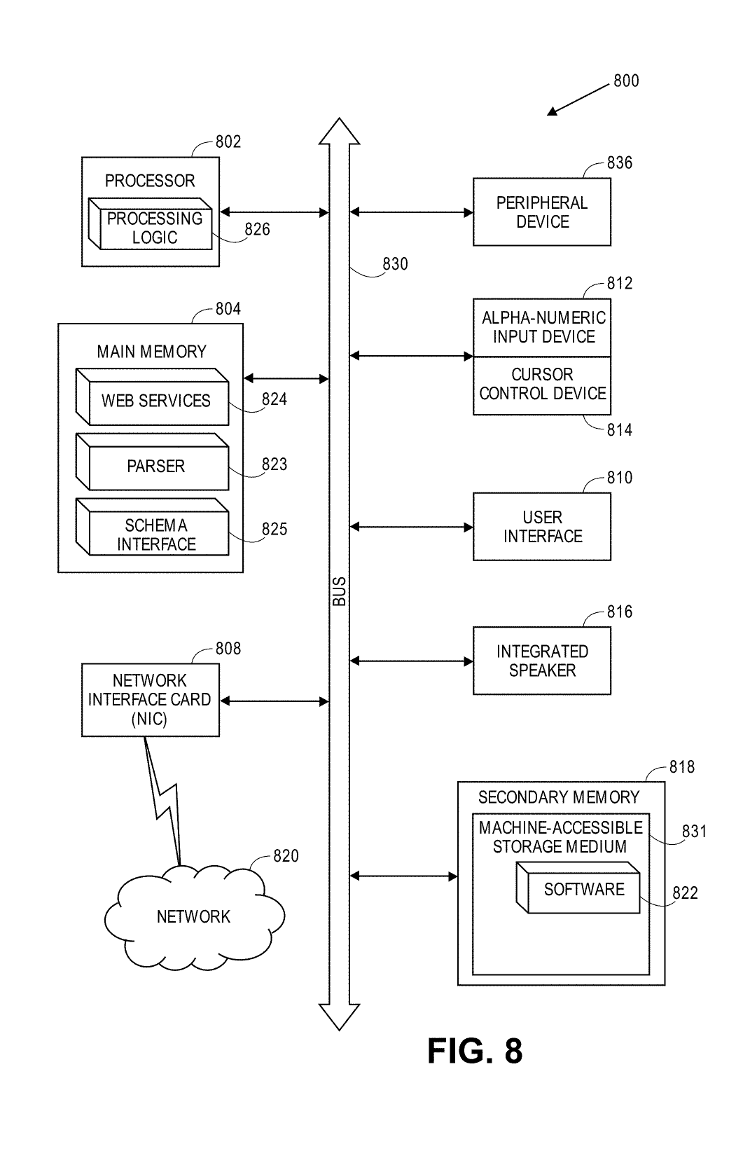

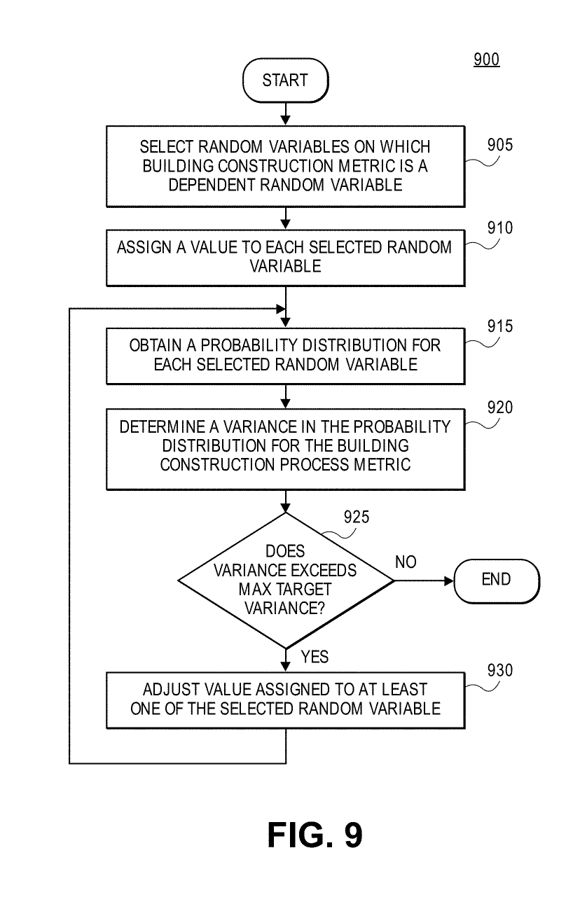

For example, with reference to FIGS. 8 and 9, an embodiment of the invention includes a method 900 executed by a computer system for receiving user input to select a variance, e.g., a maximum target variance, in a probability distribution of a building construction process metric. Metrics include such things as the cost of or timeline for a building construction process. The input may be received from a user, for example, via a user interface slider mechanism.

In one embodiment, a processor 802 executes software instructions 822 to perform the method 900. A storage device 831 accessible by the processor stores a database, and the database, in one embodiment, stores therein information regarding a building products information model (PIM), the PIM comprising a number of building products that are available for installation and/or meet certain criteria for inclusion in the building project. The database further stores therein a building information model (BIM) for the building project, the BIM comprising another number of building products that may be available for installation and/or may meet certain criteria for inclusion in the building project. A BIM in one embodiment is a digital representation of a 3D-based model of and corresponding process for a facility. The BIM gives architecture, engineering, and construction (AEC) professionals insight and tools to plan, design, construct, and manage the physical and functional characteristics of the facility, whether a building, an infrastructure project, or a place.

Building information modeling (BIM) involves representing a design as one or more combinations of objects, which may be vague and undefined, generic or product-specific, solid shapes, or void-space oriented (like the shape of a room), that include their geometry, relations and attributes. BIM-based design tools allow creating different views for a building project for drawing production and other uses. These different views are automatically consistent, being based on a single definition of each object instance. BIM based software may also defines objects parametrically. That is, the objects are defined as parameters and relations to other objects, so that if a related object is amended, dependent ones will automatically also change. Each BIM object can include attributes for selecting and ordering them automatically, providing cost estimates, and for material tracking and ordering, among other attributes.

The database further stores therein probability distributions for any number of random variables corresponding to building process elements. A building process element may, for example, include a building element cost, a building element availability and lead time, a building element manufacturing cost, a building element manufacturing time, a building element installation cost, a building element installation time, building element transportation cost, building element transportation time, building element sustainability, building element reliability, building element structural loading capacity.

In one embodiment, software instructions 822 executed by the processor 862 cause the system at 905 to select one or more of the random variables (y1, y2, . . . yₙ) on which the building construction process metric (X) is a dependent random variable (X (y1, y2, . . . yₙ)). In other words, the embodiment causes the system to select one or more random variables, and the construction process metric is a function of the selected one or more random variables. In one embodiment, a user interface (UI) 810 receives input from a user that the system uses to select the one or more random variables. The input may be received from a user, for example, via a user interface slider mechanism. In another embodiment, the system automatically selects by software the one or more random variables. At 910, software automatically assigns a value range to each selected random variable. In another embodiment, the UI 810 receives input from a user to assign the value range to a selected random variable. The input may be received from a user, for example, via a user interface slider mechanism.

The software instructions then cause the system to obtain from the database that stores probability distributions for the random variables a probability distribution for each selected random variable, at 915. In one embodiment, the probability distribution is based on its assigned value range.

At 920, the software instructions cause the system to determine a variance in the probability distribution for the building construction process metric based on a calculation involving the assigned value, and the obtained probability distribution, for each selected random variable. For example, the system determines a variance in probability distribution for time to completion (TTC) based on the calculation TTC=T1+T2+T3+T4.

In one embodiment, the system checks whether the variance exceeds the maximum target value, at 925. When the determined variance does in fact exceed the maximum target variance, the software instructions cause the system to adjust the value assigned to at least one of the selected random variables and/or select a new one or more of the plurality of random variables on which the building construction process metric is a dependent random variable, at 930, and then repeat the process described above, beginning at 915: obtain a new probability distribution for each newly selected random variable (e.g., based on its adjusted assigned value), and determine a new variance in the probability distribution for the construction process metric based on a new calculation involving the adjusted assigned value, and the obtained new probability distribution, for each newly selected random variable based on its adjusted assigned value. The embodiment continues in this manner until the system determines a variance in the probability distribution for the construction process metric that does not exceed the maximum target variance.

With reference to FIGS. 1A and 8, processing logic 105 receives input to select one or more geographic-based factors to consider in selecting a building site. In one embodiment, the input is received from a user, for example, via a keyboard, and/or in the absence of such the embodiment relies on machine input to select the one or more geographic-based factors to consider in selecting a building site. In another embodiment, an initial or default set of geographic-based factors are selected by the system. As examples, geographic-based factors such as median income, job growth rate, single or multi-family home value, property tax rate, and crime rate may be considered. In another embodiment, additional geographic-based factors such as geological hazards (steep slopes, landslide activity, flood zone, fire zone, earthquake hazards), noise complaints/variances, land use (districts: historic, business, conservation, etc.), and jurisdictional boundaries (state, county, city, school district, zoning).

One embodiment of the invention allows for weighting of one or more of the selected geographic-based factors. So, for example, if two geographic-based factors, such as median income and job growth, are selected, the embodiment receives input that may weight one factor at greater than 50% and the then weights the other factor correspondingly less than 50%. In another embodiment, if more than two geographic-based factors (GFₙ) are selected, user input is received for at least GFₙ₋₁ geographic-based factors and the embodiment then weights the n selected geographic-based factors accordingly.

Processing logic at 110 further receives input to select a range of values for one or more of the selected geographic-based factors to consider in selecting a building site. In one embodiment, the input is received from a user, for example, via a keyboard or mouse, and/or in the absence of such the embodiment relies on machine input to select the range of values for one or more of the selected geographic-based factors to consider in selecting a building site. In another embodiment, an initial or default range is configured for each selected geographic-based factor by the system.

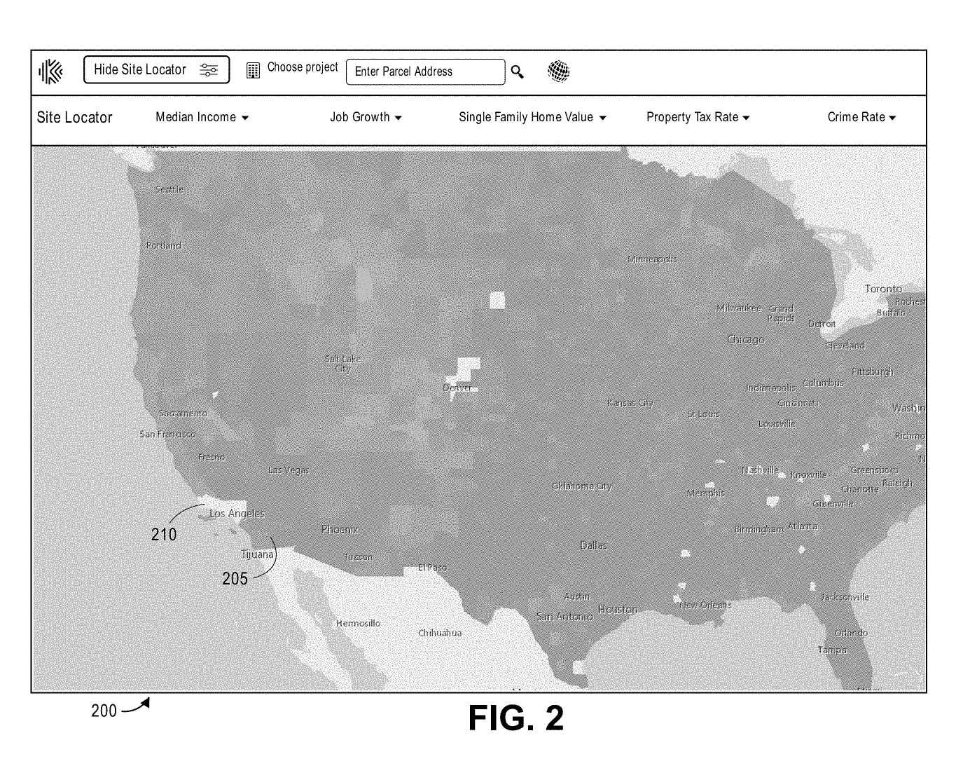

According to an embodiment, with reference to FIG. 2, processing logic 115 displays a map 200 on a display screen. The map depicts a number of geographic regions, e.g., 205, 210. In one embodiment, the geographic boundaries may encompass one or more state counties or boroughs, or portions thereof. In one embodiment, the geographic regions are depicted in a manner that indicates a relative desirability, or score, or index, or rating, of a building site in the geographic region based on the selected building-design rules, any selected user-based factors, and geographic-based factor(s) and the selected range of values for the one or more of the selected building-design rules, any selected user-based factors, and geographic-based factors. In various embodiments, the manner that indicates the relative score may be a presented as one or more of a numerical, alphabetical, or alphanumeric index, a particular color, a shading of a particular color, a wireframe map display, a contour map display, or topographical map display on the display screen.

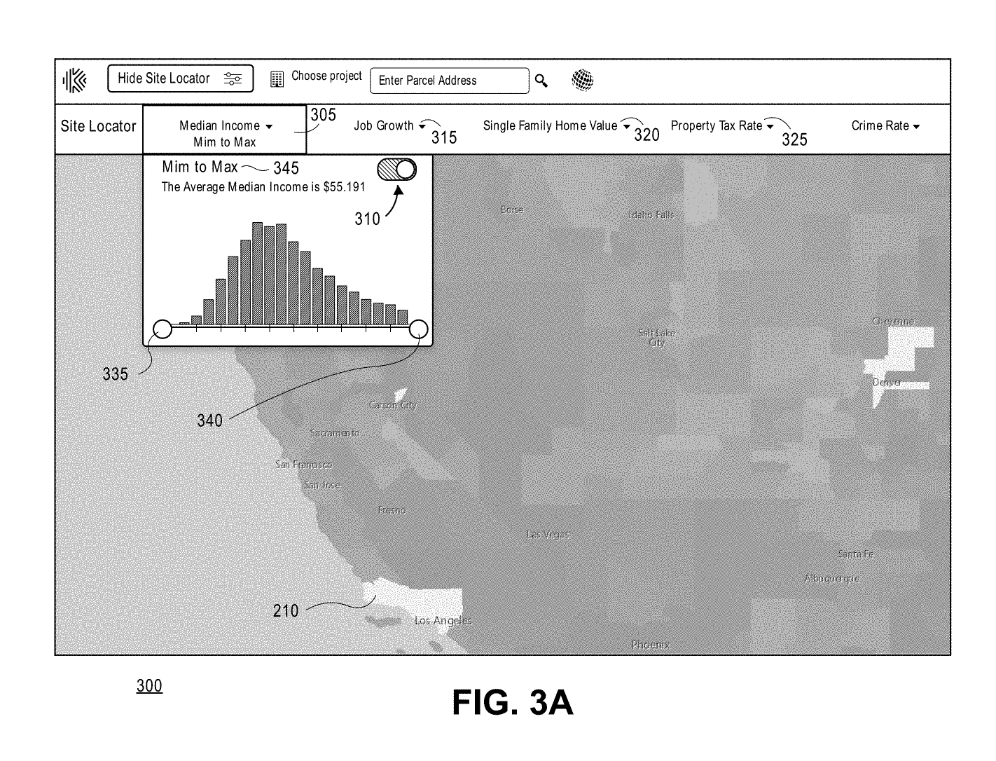

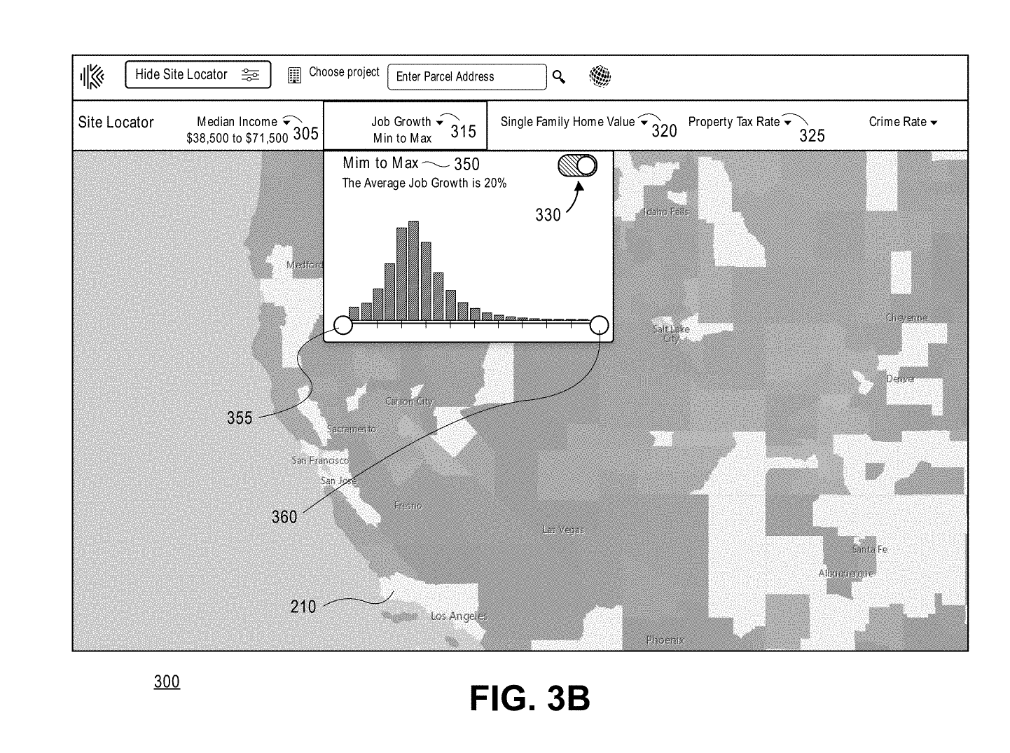

With reference to FIG. 3A, one embodiment 300 of the processing logic 105 that receives input to select one or more geographic-based factors to consider in selecting a building site is illustrated. In the embodiment, input is received from a user, for example, via a mouse, at 305, 315, 320 and 325, via a pull down menu, to select the one or more geographic-based factors to consider in selecting a building site. In the illustrated embodiment, a median income factor is accessed at 305, and selected via the user interface toggle mechanism 310. Likewise, the job growth factor is accessed at 315, the home value factor accessed at 320, and the property tax factor accessed at 325. Each of those geographic-based factors, once accessed, likewise provides a user interface toggle mechanism like mechanism 310, by which a user can select the respective factor for consideration in selecting a building site. For example, FIG. 3B illustrates accessing the job growth factor via pull down menu at 315 and selecting the factor at 330.

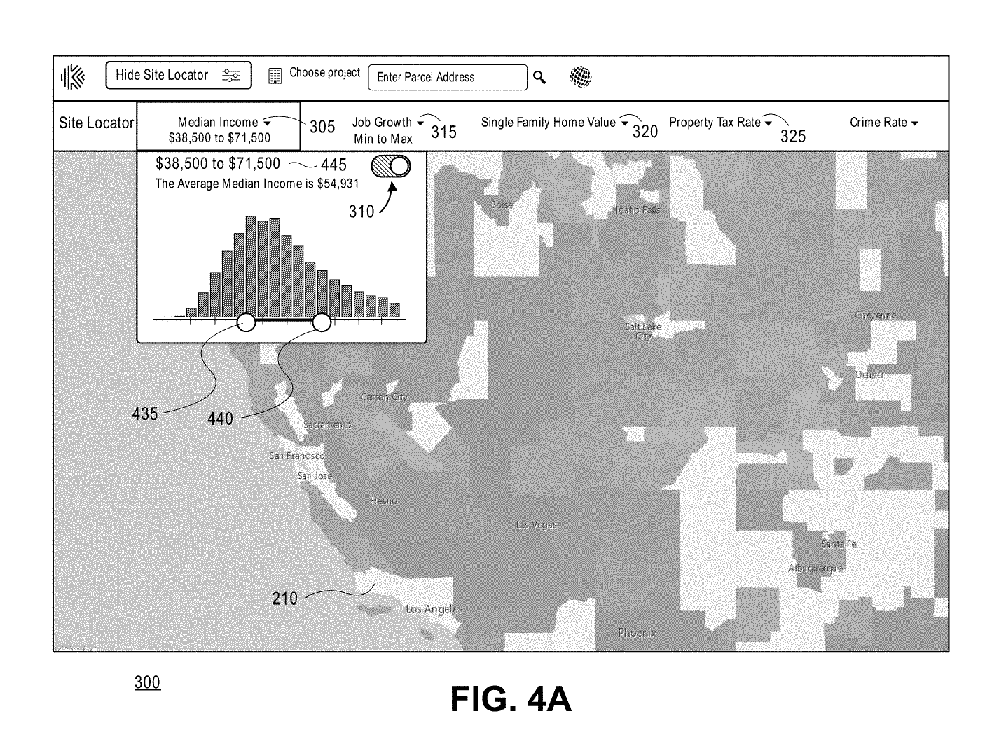

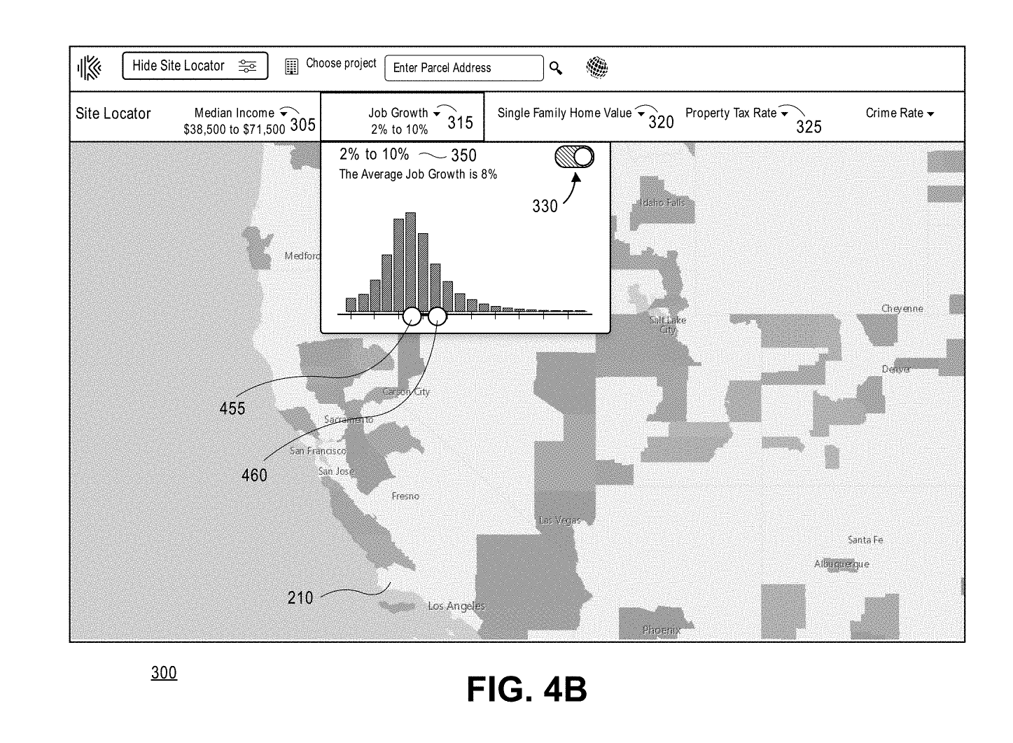

Further with respect to FIGS. 3A and 4A, one embodiment of the processing logic 110 that receives input to select a range of values for one or more of the selected geographic-based factors to consider in selecting a building site is illustrated. In the embodiment, an initial or default range is configured for a selected factor by the system. For example, selected factor 305—median income—has an initial of default range of min to max (345), wherein the min 335 is some minimum amount, and the max 340 is some maximum amount. In the embodiment, as depicted in FIG. 4A, input is received from a user at 435 and 440, for example, via a user interface slider mechanism, to change the range of values for the selected median income factor from an initial or default min at 335 to a new, user selected min at 435 of $38,500 in median income and from an initial or default max at 340 to a new, user selected max at 440 of $71,500 in median income. Likewise, with reference to FIG. 4B, selected factor 315—job growth rate—has an initial of default range of min to max (350), wherein the min 355 is some minimum amount, and the max 360 is some maximum amount. In the embodiment, as depicted in FIG. 4B, input is received from a user at 455 and 460, for example, via the user interface slider mechanism, to change the range of values for the selected job growth rate factor from an initial or default min at 355 to a new, user selected min at 455 of 2% in job growth rate and from an initial or default max at 360 to a new, user selected max at 460 of 10% in job growth rate.

As can be seen by comparing the map displays illustrated in FIGS. 3A and 4A, by changing the range of values of the selected factor median income, note the change in the manner (e.g., color) that indicates a relative score for a building site in the displayed geographic regions based on that selected factor, and in particular, based on the change of the selected range of values for that selected factor. Many of the displayed geographic regions changed color, indicating a change in the score for a building side in the displayed geographic regions based on the change in the selected range of median income. Likewise, comparing the map displays illustrated in FIGS. 3B and 4B, one can readily see that by changing the range of values of the selected factor job growth rate, there is a change in the color that indicates a relative score for a building site in many of the displayed geographic regions based on that selected factor, and in particular, based on the change of the selected range of values for that selected factor. Many of the displayed geographic regions changed color, indicating a change in the score for a building side in the displayed geographic regions based on the change in the selected range of job growth rate.

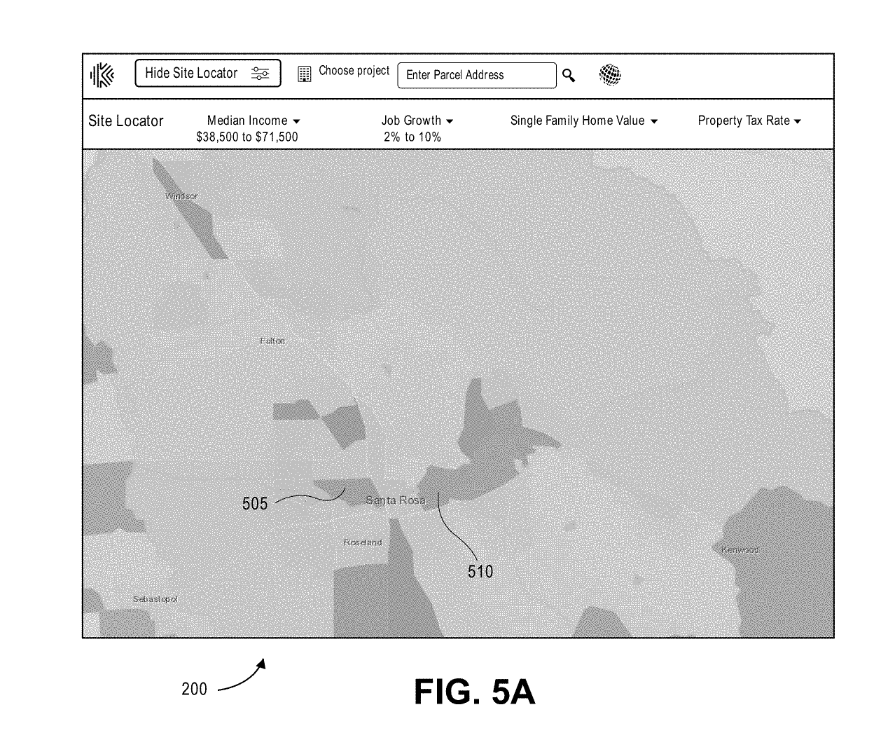

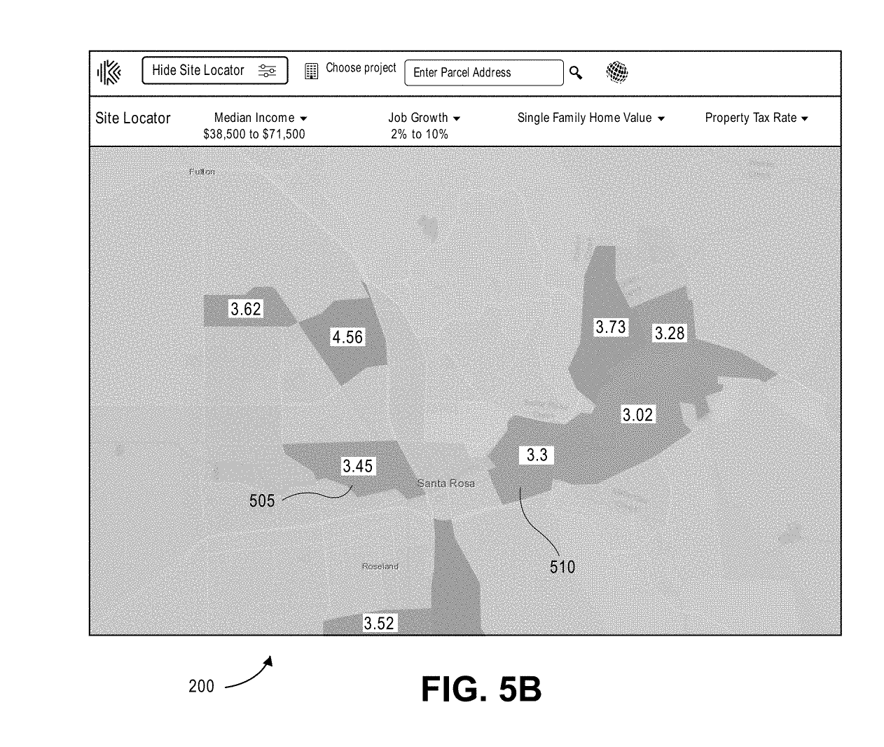

With reference to FIG. 5A, processing logic at 120 receives user input, for example, by the user double clicking on a computer mouse, to “drill down”, or zoom, into the map display 200 to subdivide one or more of the displayed geographic regions into two or more geographic sub-regions, such as cities, townships, or census tracts. The user can continue to drill down, for example, by double clicking one or more additional times until, as depicted in FIG. 5A, the map display 200 is subdivided into geographical sub-regions, such as geographical sub-regions 505 and 510. With reference to FIG. 5B, the user can continue to further drill down until the map display 200 displays at 125 a relative score for a building site in each of the selected geographic sub-regions based on the selected factor(s) and the selected range of values for the selected factor(s). For example, in FIG. 5B, the geographic sub-region 505 is illustrated using a particular color, and/or is overlaid with a numerical index having a value of 3.45, and geographic sub-region is displayed in another color and/or overlaid with a numerical index having a value of 3.3. Thus, embodiments of the invention allow a user to set “desirability” or a search criteria for GIS data. The system then creates a set of new, dynamic maps, visible at various scales, which synthesizes many dimensions of data into a 2D representation.

Thus, embodiments of the invention provide for a system and method of selecting a geographic region, or sub-region therein, for a building site for a construction project, including receiving input to select one or more factors to consider in selecting a building site. receiving input to select a range of values for one or more of the selected factor(s), displaying a map depicting each of a plurality geographic regions in a manner that indicates a relative score for a building site in the geographic region based on the selected factor(s) and the selected range of values for the one or more of the selected factor(s), receiving user input to subdivide one of the plurality of geographic regions into a plurality of geographic sub-regions, and redisplaying the map depicting each of the plurality geographic sub-regions in a manner that indicates the relative score for a building site in the geographic sub-region based on the selected factor(s) and the selected range of values for the one or more of the selected factor.

The process described above with reference to FIG. 1A can be iterative, and even automated, wherein a user provides initial input on the selected generative design rules, any selected user-based factors, and selected geographic-based factors, and the respective range of values for those selected rules and factors, and the system can create a short video clip, or a series of different map displays, wherein each “frame” is based on a different set of selected rules and factors and/or respective selected range of values thereof, and displayed for a short duration of time to give the effect of a moving picture display that shows changes in the “heat map” display as the generative design rule inputs and user-based and/or geographic-based factor inputs are cycled through while searching for an optimum building site based on any criteria, such as, for example, ROI, or market value.

Given the above embodiments of the invention, a user, according to further embodiments of the invention, is then able to receive user input to display a plurality of property parcels for or within one of the plurality of geographic sub-regions, and receive user input to select one or more of the displayed plurality of property parcels on which to perform a function, as described below.

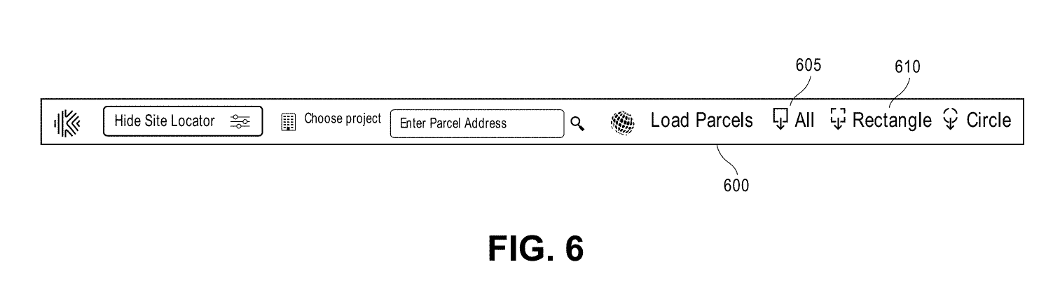

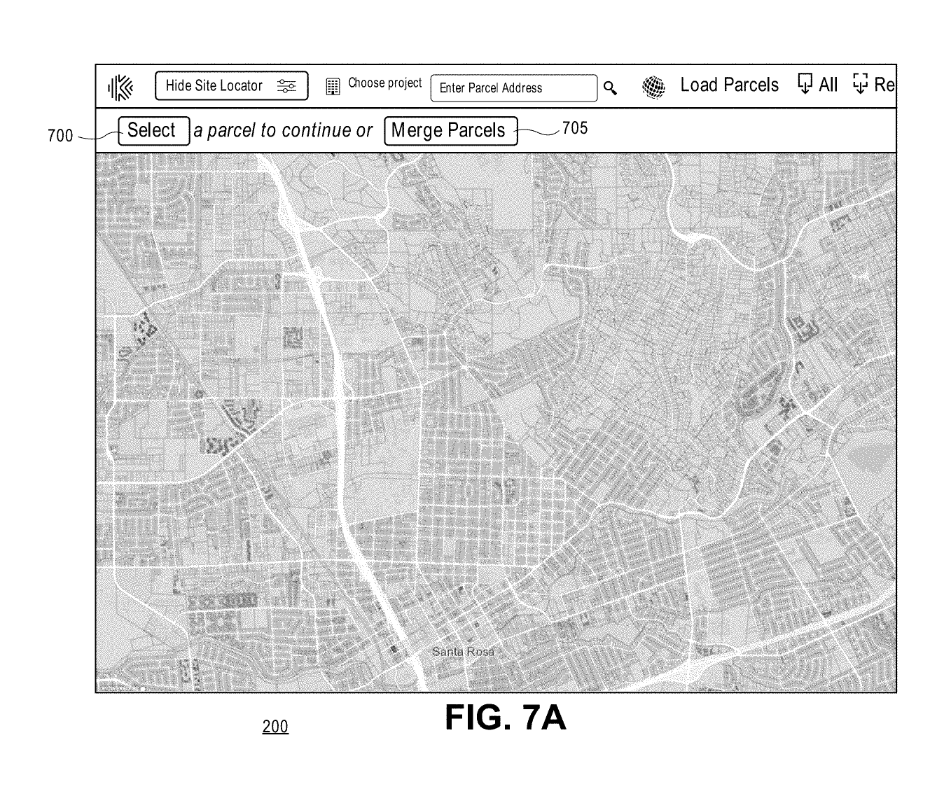

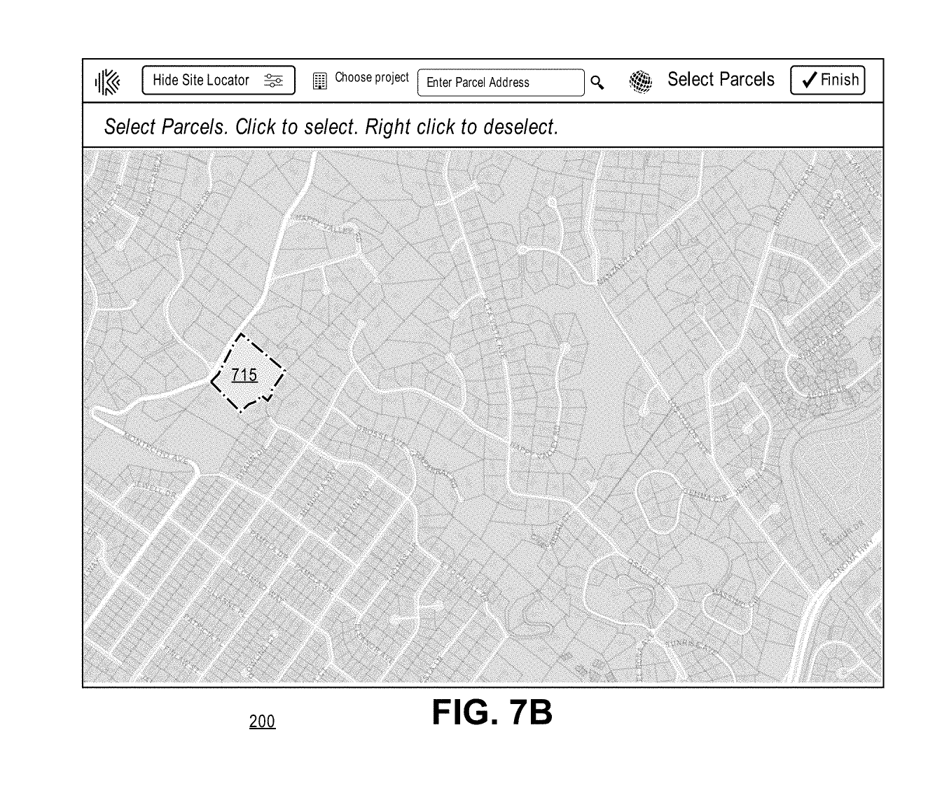

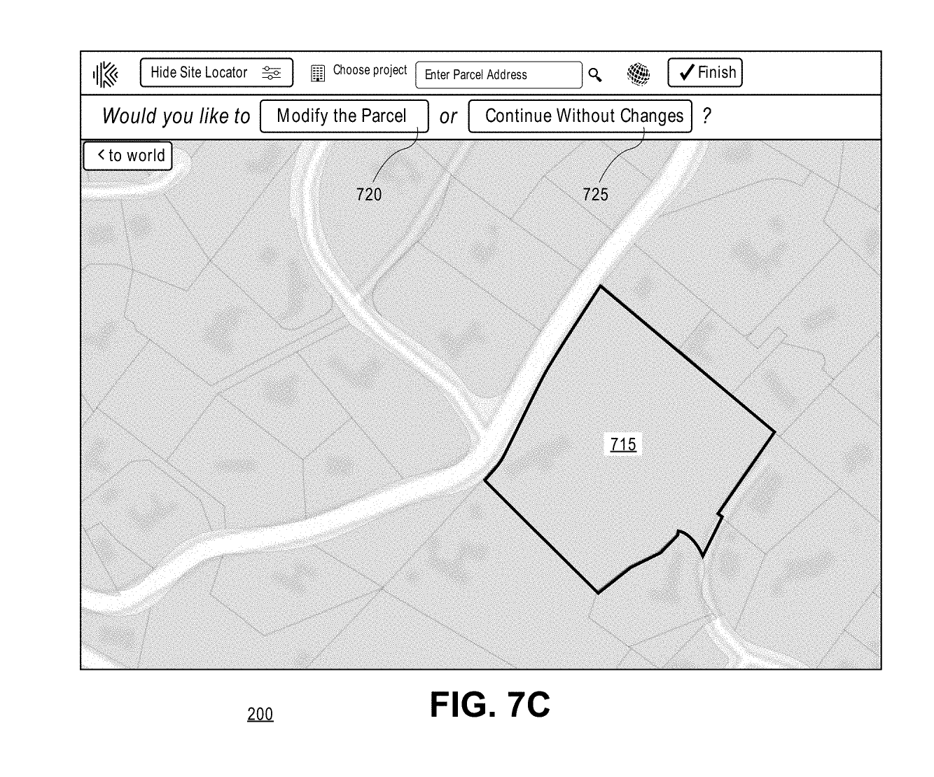

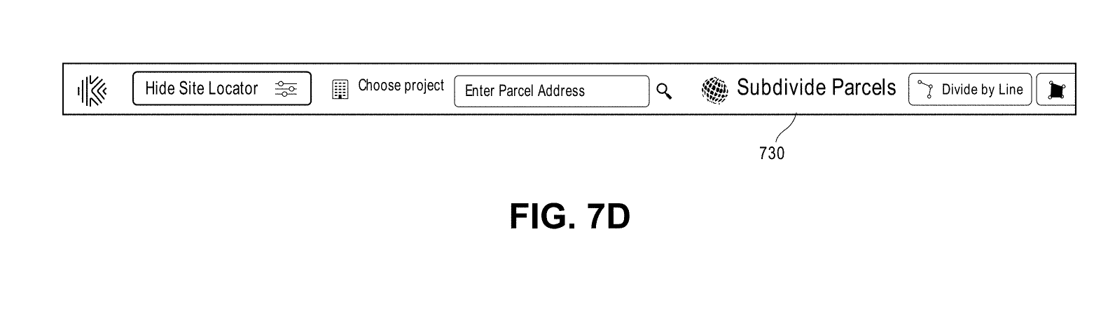

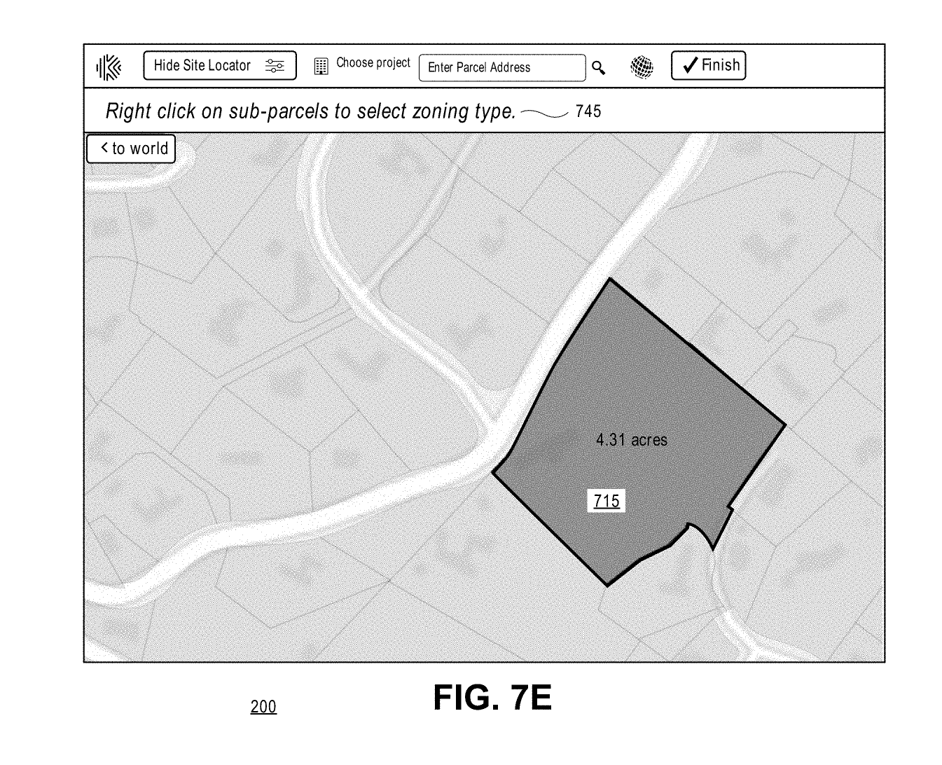

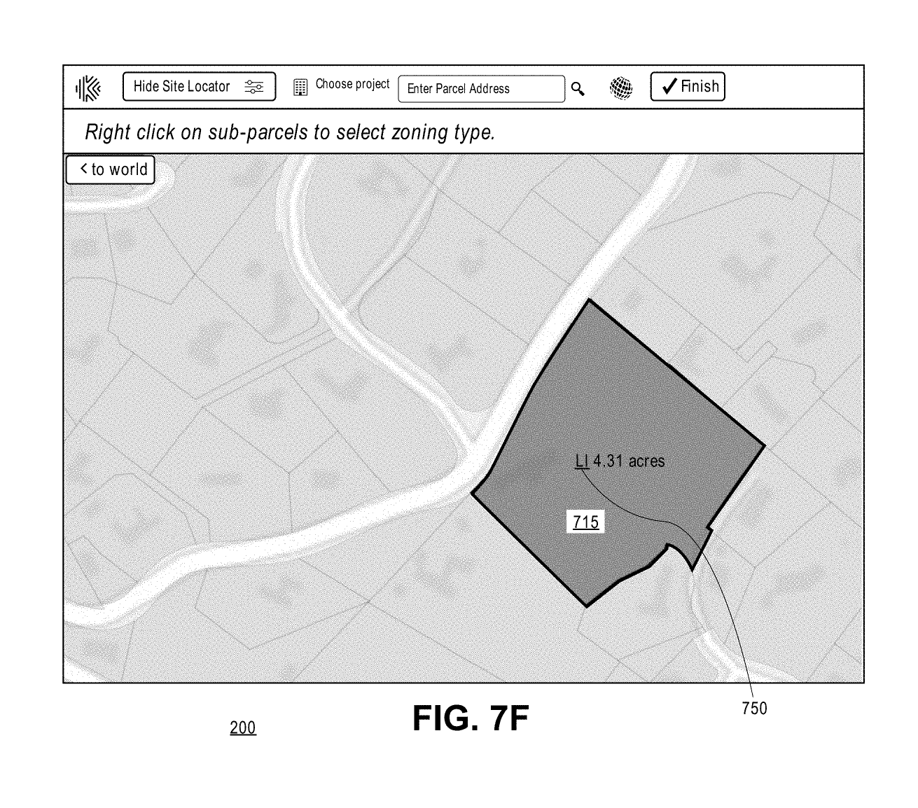

With respect to FIGS. 1B and 6, further embodiments of the invention include processing logic 130 that receives user input to display a number of property parcels within one or more of the geographic sub-regions. For example, the user can select a user interface button 600 to load parcels on the map display 200, and then select a user interface button 605 to load all parcels within the display, select a user interface button 610 to load all parcels defined by a selected rectangle (created by clicking and dragging the computer mouse from one point to another point on the map display), or select a user interface button (not shown) to load all parcels defined by a selected circle created by clicking and dragging the computer mouse along a radius from a center point selected on the map to an outer point on the circumference of the circle. FIG. 7A depicts map display 200 with all the property parcels for the geographic sub-regions in map display 200, responsive to receiving user input to load all parcels within the display. Processing logic 135 then is able to receive user input to select one or more of the property parcels, for example, to perform some function on or with the parcels. For example, a user can click on the “select a parcel to continue” button 700, or select multiple parcels to be merged, and then, with reference to FIG. 7B, select the parcel, each of which is then outlined in a dotted line as in FIG. 7B. In the example illustrated in FIG. 7B, a single parcel 715 is selected, and displayed as depicted in FIG. 7C.

At processing logic block 140, a function can be performed on the one or more selected property parcels. In one embodiment, processing logic 140 receives user input to select one or more of the displayed plurality of property parcels on which to perform a function, and selects the function to perform, such as modify a parcel as prompted at user interface button 720. In the example illustrated in FIG. 7C, the user can click on the “modify the parcel” button at 720, and is then presented as illustrated in FIG. 7D with an action to perform 730, such as subdivide—split parcel, divide by line, divide by polygon. Alternatively, the user can click on the “continue without changes” button 725 as illustrated in FIG. 7C and is then presented the map display 200 as illustrated in FIG. 7D with an action to perform 740, such as select zoning type for the selected sub-parcels, as depicted at 745. In one example, the user is presented with a pull-down menu (not shown) overlaid on map display 200 from which the user can select one of a number of zoning types. In the example illustrated in FIG. 7F, the user selects zoning type “LI” (Light Industrial), and then parcel 715 is identified at 750 as zoning type “LI”. It is appreciated that user can perform other functions once one or more parcels are selected, such as generating a pro forma, also known as a “Unit Matrix”, for constructing a building on the site defined by the one or more selected parcels. This process may be iterative as well. For example, a site may be re-evaluated based on the selected one or more factors, and/or and the selected range of values for the one or more of the selected factors, and then modified (again), and so on.

FIG. 8 illustrates a diagrammatic representation of a machine 800 in the exemplary form of a computer system, in accordance with one embodiment, within which a set of instructions, for causing the machine 800 to perform any one or more of the methodologies discussed herein, may be executed. In alternative embodiments, the machine may be connected, networked, interfaced, etc., with other machines in a Local Area Network (LAN), a Wide Area Network, an intranet, an extranet, or the Internet. The machine may operate in the capacity of a server or a client machine in a client-server network environment, or as a peer machine in a peer to peer (or distributed) network environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processor 802, a main memory 804 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), etc.), and a secondary memory 818, which communicate with each other via a bus 830. Main memory 804 includes information and instructions and software program components necessary for performing and executing the functions with respect to the various embodiments of the systems, methods for implementing embodiments of the invention described herein. Instructions 823 may be stored within main memory 804. Main memory 804 and its sub-elements are operable in conjunction with processing logic 826 and/or software 822 and processor 802 to perform the methodologies discussed herein.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processing devices such as an application specific integrated circuit (ASIC), a field programmable gate array (FPGA), a digital signal processor (DSP), network processor, or the like. Processor 802 is configured to execute the processing logic 826 for performing the operations and functionality which are discussed herein.

The computer system 800 may further include one or more network interface cards 808 to interface with the computer system 800 with one or more networks 820. The computer system 800 also may include a user interface 810 (such as a video display unit, a liquid crystal display (LCD), or a cathode ray tube (CRT)), an alphanumeric input device 812 (e.g., a keyboard), a cursor control device 814 (e.g., a mouse), and a signal generation device 816 (e.g., an integrated speaker). The computer system 800 may further include peripheral device 836 (e.g., wireless or wired communication devices, memory devices, storage devices, audio processing devices, video processing devices, etc.). The computer system 800 may perform the functions of determining and instructing a traffic signal to carry out the green lights activity and phase timings as determined by such a system 1000 as described herein.

The secondary memory 818 may include a non-transitory machine-readable storage medium (or more specifically a non-transitory machine-accessible storage medium) 831 on which is stored one or more sets of instructions (e.g., software 822) embodying any one or more of the methodologies or functions described herein. Software 822 may also reside, or alternatively reside within main memory 804, and may further reside completely or at least partially within the processor 802 during execution thereof by the computer system 800, the main memory 804 and the processor 802 also constituting machine-readable storage media. The software 822 may further be transmitted or received over a network 820 via the network interface card 808.

Some portions of this detailed description are presented in terms of algorithms and representations of operations on data within a computer memory. These algorithmic descriptions and representations are the means used by those skilled in the data processing arts to most effectively convey the substance of their work to others skilled in the art. An algorithm is here, and generally, conceived to be a sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from this discussion, it is appreciated that throughout the description, discussions utilizing terms such as “processing” or “computing” or “calculating” or “determining” or “displaying” or the like, refer to the action and processes of a computer system or computing platform, or similar electronic computing device(s), that manipulates and transforms data represented as physical (electronic) quantities within the computer system's registers and memories into other data similarly represented as physical quantities within the computer system memories or registers or other such information storage, transmission or display devices.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software, including software instructions that perform the operations described herein via memory and one or more processors of a computing platform.

Embodiments of invention also relate to apparatuses for performing the operations herein. Some apparatuses may be specially constructed for the required purposes, or may comprise a general purpose computer(s) selectively activated or configured by a computer program stored in the computer(s). Such a computer program may be stored in a computer readable storage medium, such as, but not limited to, any type of disk including optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms presented herein are not inherently related to any particular computer or other apparatus. Various general purpose systems may be used with programs in accordance with the teachings herein, or it may prove convenient to construct more specialized apparatus to perform the required methods. The structure for a variety of these systems appears from the description herein. In addition, embodiments of the invention are not described with reference to any particular programming language. It will be appreciated that a variety of programming languages may be used to implement the embodiments of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices, etc.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. A method of selecting a geographic region, or sub-region therein, for a building site for a construction project, comprising:
receiving input to select one or more generative design rules to consider in selecting a building site;
receiving input to select a range of values for one or more of the selected generative design rules;
receiving input to select one or more geographic-based factors to consider in selecting a building site;
receiving input to select a range of values for one or more of the selected geographic-based factor(s);
displaying a map depicting each of a plurality geographic regions in a manner that indicates a relative score for a building site in the geographic region based on the selected generative design rules and the selected geographic-based factor(s) and the respective selected range of values for the one or more of the selected generative design rules and the selected geographic-based factor(s);
receiving user input to subdivide one of the plurality of geographic regions into a plurality of geographic sub-regions; and
redisplaying the map depicting each of the plurality geographic sub-regions in a manner that indicates the relative score for a building site in the geographic sub-region based on the selected generative design rules and the selected geographic-based factor(s) and the respective selected range of values for the one or more of the selected generative design rules and the selected geographic-based factor(s).

2. The method of claim 1, further comprising:
receiving user input to display a plurality of property parcels for or within one of the plurality of geographic sub-regions; and
receiving user input to select one or more of the displayed plurality of property parcels on which to perform a function.

3. The method of claim 1, wherein receiving input to select one or more generative design rules to consider in selecting a building site comprises receiving one or more of user input or machine input to select one or more generative design rules to consider in selecting a building site, and wherein receiving input to select one or more geographic-based factors to consider in selecting a building site comprises receiving one or more of user input or machine input to select the one or more geographic-based factors to consider in selecting a building site.

4. The method of claim 3, further comprising weighting the one or more of the selected generative design rules and the selected geographic-based factor(s).

5. The method of claim 1, wherein receiving input to select a range of values for one or more of the selected generative design rules comprises receiving one or more of user input or machine input to select the range of values for the selected generative design rules, and wherein receiving input to select a range of values for one or more of the selected geographic-based factor(s) comprises receiving one or more of user input and machine input to select a range of values for the one or more of the selected geographic-based factor(s).

6. A system for selecting a geographic region, or sub-region therein, for a building site, comprising:
a processor to execute software instructions;
a storage device accessible by the processor in which to store a database, the database to store therein information regarding a plurality of geographic regions, a plurality of sub-regions, one or more factors for consideration in selecting a building site, and a range of values for the one or more of the factors;
a user interface (UI) via which to receive input and transmit output according to software instructions executed by the processor; and
software instructions that when executed by the processor cause the system to:
receive input to select one or more generative design rules to consider in selecting a building site;
receive input to select a range of values for one or more of the selected generative design rules;
receive input to select one or more geographic-based factors to consider in selecting a building site;
receive input to select a range of values for one or more of the selected geographic-based factor(s);
display a map on a display screen depicting each of a plurality geographic regions in a manner that indicates a relative score for a building site in the geographic region based on the selected generative design rules and the selected geographic-based factor(s) and the respective selected range of values for the one or more of the selected generative design rules and the selected geographic-based factor(s);
receive user input to subdivide one of the plurality of geographic regions into a plurality of geographic sub-regions; and
redisplay the map on the display screen depicting each of the plurality geographic sub-regions in a manner that indicates the relative score for a building site in the geographic sub-region based on the selected generative design rules and the selected geographic-based factor(s) and the respective selected range of values for the one or more of the selected generative design rules and the selected geographic-based factor(s).

7. The system of claim 6, further comprising software instructions to:
receive user input to display on the display screen a plurality of property parcels for or within one of the plurality of geographic sub-regions; and
receive user input to select one or more of the displayed plurality of property parcels on which to perform a function.

8. The system of claim 6, wherein the software instructions that cause the system to receive input to select one or more generative design rules to consider in selecting a building site comprises software instructions to receive one or more of user input or machine input to select one or more generative design rules to consider in selecting a building site, and wherein the software instructions to cause the system to receive input to select one or more geographic-based factors to consider in selecting a building site comprises software instructions to receive one or more of user input or machine input to select the one or more geographic-based factors to consider in selecting a building site.

9. The system of claim 8, further comprising software instructions to receive input to weight the one or more of the selected generative design rules and the selected geographic-based factor(s).

10. The system of claim 6, wherein the software instructions to receive input to select a range of values for one or more of the selected generative design rules comprises software instructions to receive one or more of user input or machine input to select the range of values for the selected generative design rules, and wherein the software instructions to receive input to select a range of values for one or more of the selected geographic-based factor(s) comprises software instructions to receive one or more of user input and machine input to select a range of values for the one or more of the selected geographic-based factor(s).

11. Non-transitory computer readable storage media having instructions stored thereon that, when executed by a computer system, having at least a processor and a memory therein, and access to a database, cause the system to perform the steps of:
receive input to select one or more generative design rules to consider in selecting a building site;
receive input to select a range of values for one or more of the selected generative design rules;
receive input to select one or more geographic-based factors to consider in selecting a geographic region, or sub-region therein, for a building site;
receive input to select a range of values for one or more of the selected geographic-based factor(s);
display a map on a display screen depicting each of a plurality geographic regions in a manner that indicates a relative score for a building site in the geographic region based on the selected generative design rules and the selected geographic-based factor(s) and the respective selected range of values for the one or more of the selected generative design rules and the selected geographic-based factor(s);
receive user input to subdivide one of the plurality of geographic regions into a plurality of geographic sub-regions; and
redisplay the map on the display screen depicting each of the plurality geographic sub-regions in a manner that indicates the relative score for a building site in the geographic sub-region based on the selected generative design rules and the selected geographic-based factor(s) and the respective selected range of values for the one or more of the selected generative design rules and the selected geographic-based factor(s).

12. The non-transitory computer readable storage media of claim 11, further comprising instructions that cause the system to:
receive user input to display on the display screen a plurality of property parcels for or within one of the plurality of geographic sub-regions; and
receive user input to select one or more of the displayed plurality of property parcels on which to perform a function.

13. The non-transitory computer readable storage media of claim 11, wherein the software instructions that cause the system to receive input to select one or more generative design rules to consider in selecting a building site comprises software instructions to receive one or more of user input or machine input to select one or more generative design rules to consider in selecting a building site, and wherein the software instructions that cause the system to receive input to select one or more geographic-based factors to consider in selecting a building site comprise instructions to receive one or more of user input or machine input to select the one or more geographic-based factors to consider in selecting a building site.

14. The non-transitory computer readable storage media of claim 11, further comprising instructions that cause the system to receive input to weight the one or more of the selected generative design rules and the selected geographic-based factor(s).

15. The non-transitory computer readable storage media of claim 11, wherein the software instructions to cause the system to receive input to select a range of values for one or more of the selected generative design rules comprises software instructions to cause the system to receive one or more of user input or machine input to select the range of values for the selected generative design rules, and wherein the software instructions to cause the system to receive input to select a range of values for one or more of the selected geographic-based factor(s) comprise instructions to cause the system to receive one or more of user input and machine input to select a range of values for the one or more of the selected geographic-based factor(s).
